(19) United States
(12) Patent Application Publication
(10) Pub. No.: US 2017/0344463 A1
(43) Pub. Date: Nov. 30, 2017

(54) SYSTEM AND METHOD FOR BYPASSING EVASION TESTS WITH APPLICATIONS IN ANALYSIS AND MONITORING OF MOBILE APPLICATIONS

(71) Applicant: International Business Machines Corporation, Armonk, NY (US)

(72) Inventors: Luciano Bello, Goeteborg (SE); Pietro Ferrara, Mestre-Venice (IT); Marco Pistoia, Amawalk, NY (US); Omer Tripp, Bronx, NY (US)

(21) Appl. No.: 15/166,817

(22) Filed: May 27, 2016

(51) Int. Cl. G06F 11/36

(52) U.S. Cl. CPC G06F 11/3668

(57) ABSTRACT

A given program is said to be evasive when it performs different behaviors under different running conditions. In general, the aim of evasion is to make the analysis, monitoring or reverse engineering of the given software system harder for an analyzer. Evasion is largely used by malware to increase its effectiveness. Aspects of the invention include a system, method and computer program product to detect and bypass evasion mechanisms for software analysis. Given a set of fingerprinting sources and a program, we first search for evasion candidates. These are program slices where the data depending on fingerprinting sources is used at branching point. In a second step, instrumentation strategies are applied to generate programs where the combination of possible branches is forced via toggling of return values and/or expression values. Finally, the resulting programs are each executed dynamically to monitor deltas between observed behaviors across the original and instrumented versions.

### BACKGROUND

Aspects of the present invention generally relate to a system, method, and computer program product for detecting and bypassing evasion mechanisms for software analysis.

A given program is said to be evasive when it performs different behaviors under different running conditions. In general, the aim of evasion is to make the analysis, monitoring or reverse engineering of the given software system harder for an analyzer. Evasion is largely used by malware to increase its effectiveness. However, this evasion can be implemented by benign software as an effective way to protect intellectual property or to enforce Digital Rights Management (DRM).

In general, evasive software uses fingerprinting to characterize the environment, and based on that, changes its behavior. In this way, when it runs on testing infrastructure or in a context where its internals can be observed, the analyzed software does not trigger parts of its interesting actions. In the case of malware, these actions are usually the payload.

Several recent studies support the idea that evasion is a real and complex problem that needs to be tackled.

### SUMMARY

Aspects of the invention are a system, method, and computer readable program for a method to detect and bypass evasion mechanisms for software analysis.

An exemplary system, given a set of fingerprinting sources and a program to be tested, for determining evasion mechanisms for software analysis comprises: slicing analyzer searching for evasion candidates of all slices affecting branching points; instrumenter generating programs where the combination of branches is forced via toggling of return values and/or expression values; behavior analyzer dynamically executing each generated program to monitor differences between observed behavior across an original and instrumented version of the program, and based on the dynamically executed programs determining whether evasion is necessary.

An exemplary method, given a set of fingerprinting sources and a program to be tested, for detecting evasion mechanisms for software analysis comprises: searching for evasion candidates; generating programs where the combination of branches is forced via toggling of return values and/or expression values dynamically executing each generated program to monitor differences between observed behavior across an original and instrumented version of the program, and based on the dynamically executed programs determining whether evasion is necessary.

An exemplary non-transitory computer readable medium having computer readable program, given a set of fingerprinting sources and a program to be tested, for detecting evasion mechanisms for software analysis comprising: searching for evasion candidates; generating programs where the combination of branches is forced via toggling of return values and/or expression values; dynamically executing each generated program to monitor differences between observed behavior across an original and instrumented version of the program, and based on the dynamically executed programs determining whether evasion is necessary.

The objects, features, and advantages of the present disclosure will become more clearly apparent when the following description is taken in conjunction with the accompanying drawings.

### BRIEF DESCRIPTION OF THE DRAWINGS

FIG. 1 is a flow chart of an aspect of the invention.

FIG. 2 is a schematic block diagram of a system for implementing aspects of the method in FIG. 1.

FIG. 3 is a schematic block diagram of a computer system for practicing various aspects and embodiments of the invention.

### DETAILED DESCRIPTION OF PREFERRED EMBODIMENTS

Aspects of the invention are related to detecting that software is trying to evade monitoring/debugging/analysis is a feature in some automatic analyzers such as APK Analyzer—http://apk-analyzer.net/. However, this detection is based on the syntactic matching of suspicious words in the analyzed binary. The analyzer assumes that functions or constants that can be used to fingerprint the environment have particular characteristics in their userspace names.

Aspects of the invention include a novel method, system, and computer program product to detect and bypass evasion mechanisms for software analysis. Given a set of fingerprinting sources and a program, we first search for evasion candidates. These are program slices where the data depending on fingerprinting sources is used at branching point. In a second step, instrumentation strategies are applied to generate programs where the combination of possible branches is forced via toggling of return values and/or expression values. Finally, the resulting programs are each executed dynamically to monitor deltas between observed behaviors across the original and instrumented versions.

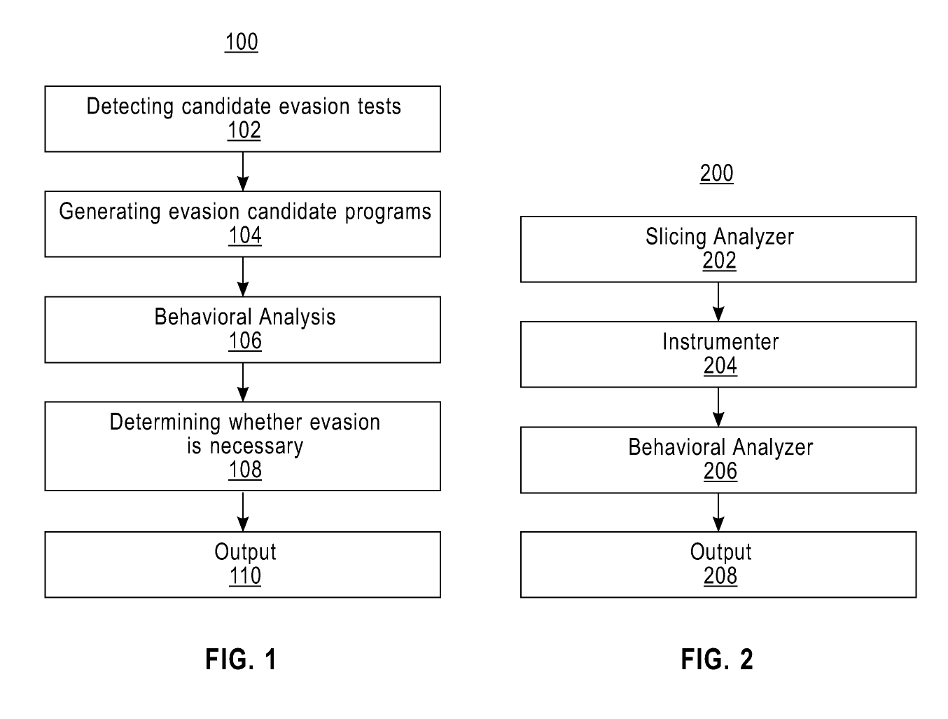

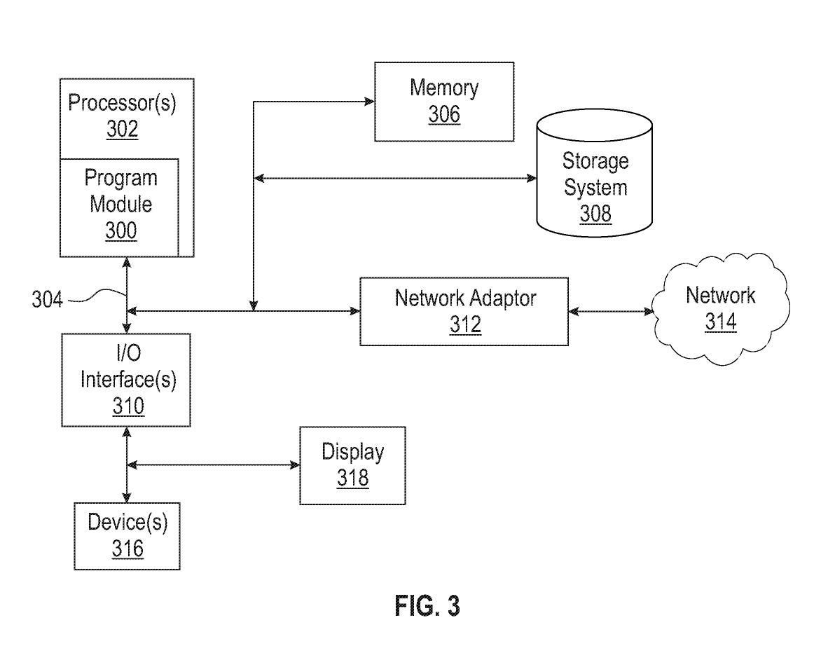

An embodiment of the invention is shown in flow chart of FIG. 1. Given a set of fingerprinting sources and a program comprises the following steps: searching for and detecting evasion candidates 102. These are program slices where the data depending on fingerprinting sources is used at branching points. Next, instrumentation strategies are applied to generate programs 104 where the combination of possible branches is forced via toggling of return values and/or expression values. Finally, behavioral analysis 106 where the resulting programs are each executed dynamically to monitor deltas between observed behaviors across the original and instrumented versions. Based on the results of the behavioral analysis, determining whether evasion is necessary 108. An output is provided to an analyst whether the program being tested requires evasion. The steps are described in more detail in conjunction with the system shown in FIG. 3.

Referring to FIG. 2 which is a schematic block diagram of a system 200 for implementing aspects of the method in FIG. 1.

A slicing analyzer 202 is used to produce candidates of internal mechanisms for evasion. Considering method calls, field accesses and constants that may obtain information regarding the execution environment as sources, and branching points and return statements as sinks. The slicing analyzer performs static reachability analysis (e.g., based on use/def chains in SSA form).

Instrumenter 204 forces a given evasion test into the other branch (e.g., the false branch if the test originally evaluated the test to true. The instrumenter with the dependency information evaluates all the slices affecting branching points, i.e., evasion candidates. The dependency information is the static analysis that is used to detect the relevant tests. The dependency information may include fingerprinting sources since it identifies tests based on a set of patterns (e.g., use of certain constants in the test). The instrumenter includes instrumentation (e.g. at bytecode level via frameworks like ASM for bytecode editing), or other means (such as platform-level instrumentation), to force different candidates to return different values to lead to the exposure of behaviors guarded by the candidate evasion tests. Forcing of the candidates is done by toggling of return values and/or expression values. This forces the untaken branch to be executed. The produced slices are used to create new programs that take all the possible branching combinations. For each combination of branch paths, a new program needs to be generated. When this method is applied on bytecode or object code, the compilation optimizer provides the minimum amount of branching nodes and indirectly optimizes this process. Each of the generated programs is a specialized version of the original program. That is, they represent a particular group of traces of the given program.

The resulting set of generated programs becomes amenable to dynamic monitoring/testing/comparison in behavioral analyzer 206. The generated programs are executed dynamically to monitor differences between observed behaviors across the original and instrumented values. In an extreme case, the instrumented program might crash as a consequence of the broken invariant guarantee by manipulating the guards. If the branch body trusts in this invariant, most probably it was not an evasion instance but a false positive. If a noticeable difference is observed in the behavior of the program as the result of toggling the evaluation of a candidate evasion test (e.g., the program suddenly begins to send suspicious SMS messages in an unexpected context), then this provides confirmation that the test is indeed fulfilling the role of checking whether evasion is necessary. In an exemplary embodiment, this can serve as a heuristic how to rank the results in the user report 208.

FIG. 3 illustrates a schematic diagram of an example computer or processing system that may implement the detecting and bypassing evasion mechanisms for software analysis. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 302, a system memory 306, and a bus 304 that couples various system components including system memory 306 to processor 302. The processor 302 may include a module 300 that performs the methods described herein. The module 300 may be programmed into the integrated circuits of the processor 302, or loaded from memory 306, storage device 308, or network 314 or combinations thereof.

Bus 304 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 306 can include computer system readable media in the form of volatile memory, such as random access memory (RAM) and/or cache memory or others. Computer system may further include other removable/non-removable, volatile/non-volatile computer system storage media. By way of example only, storage system 308 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 304 by one or more data media interfaces.

Computer system may also communicate with one or more external devices 316 such as a keyboard, a pointing device, a display 318, etc.; one or more devices that enable a user to interact with computer system; and/or any devices (e.g., network card, modem, etc.) that enable computer system to communicate with one or more other computing devices. Such communication can occur via Input/Output (I/O) interfaces 310.

Still yet, computer system can communicate with one or more networks 314 such as a local area network (LAN), a general wide area network (WAN), and/or a public network (e.g., the Internet) via network adapter 312. As depicted, network adapter 312 communicates with the other components of computer system via bus 304. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

Embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, given a set of fingerprinting sources and a program to be tested, for detecting evasion mechanisms for software analysis comprises:
searching for evasion candidates;
generating programs where the combination of branches is forced via toggling of return values and/or expression values;
dynamically executing each generated program to monitor differences between observed behavior across an original and instrumented version of the program, and
based on the dynamically executed programs determining whether evasion is necessary.

2. The method of claim 1, where the searching for evasion candidates and generating programs finds all slices affecting branching points.

3. The method of claim 1, where the generated programs are a specialized version of the program to be tested representing particular group of traces of the program to be tested.

4. The method of claim 1, where the results whether a evasion is necessary is used as a heuristic to rank results in a user report.

5. A system, given a set of fingerprinting sources and a program to be tested, determining evasion mechanisms for software analysis comprising:
slicing analyzer searching for evasion candidates of all slices affecting branching points;
instrumenter generating programs where the combination of branches is forced via toggling of return values and/or expression values;
behavior analyzer dynamically executing each generated program to monitor differences between observed behavior across an original and instrumented version of the program, and
based on the dynamically executed programs determining whether evasion is necessary.

6. The system of claim 5, where the instrumenter uses bytecode or object code and provides a minimum amount of branching nodes.

7. The system of claim 5, where the slices are used to create programs that take possible branching combinations.

8. The system of claim 5, where differences between observed behavior across an original and instrumented version of the program evasion is necessary.

9. A non-transitory computer readable medium having computer readable program, given a set of fingerprinting sources and a program to be tested, for detecting evasion mechanisms for software analysis comprising:
searching for evasion candidates;
generating programs where the combination of branches is forced via toggling of return values and/or expression values;
dynamically executing each generated program to monitor differences between observed behavior across an original and instrumented version of the program, and
based on the dynamically executed programs determining whether evasion is necessary.

10. The non-transitory computer readable medium of claim 9, where the searching for evasion candidates and generating programs finds all slices affecting branching points.

11. The non-transitory computer readable medium of claim 9, where the generated programs are a specialized version of the program to be tested representing particular group of traces of the program to be tested.

12. The non-transitory computer readable medium of claim 9, where the results whether a evasion is necessary is used as a heuristic to rank results in a user report.
